(19) United States
(12) Patent Application Publication
(10) Pub. No.: US 2026/0016389 A1
(43) Pub. Date: Jan. 15, 2026

(54) BIOLOGICAL SAMPLE ANALYSIS SYSTEM, BIOLOGICAL SAMPLE ANALYSIS METHOD, AND PROGRAM

(71) Applicant: Sony Group Corporation, Tokyo (JP)

(72) Inventor: Katsutoshi Tahara, Tokyo (JP)

(73) Assignee: Sony Group Corporation, Tokyo (JP)

(21) Appl. No.: 18/996,460

(22) PCT Filed: Jun. 15, 2023
(86) PCT No.: PCT/JP2023/022258

§ 371 Date: Jan. 17, 2025

(30) Foreign Application Priority Data
Jul. 26, 2022 (JP) 2022-118570

(51) Int. Cl. G01N 15/01; G01N 15/1434; G01N 15/149

(52) U.S. Cl. CPC G01N 15/01; G01N 15/1434; G01N 15/149

(57) ABSTRACT

To provide a technique for specifying particles having predetermined characteristics from multiple kinds of particles having different characteristics.

The present invention provides a biological sample analysis system including a detection unit that detects light generated by light irradiation to particles, and an information processing unit that processes light intensity data detected by the detection unit, in which the information processing unit executes processing of specifying particles having predetermined characteristics from multiple kinds of particles having different characteristics on the basis of the light intensity data generated by light irradiation to a sample containing particle groups including the multiple kinds of particles having different characteristics, and the like.

### TECHNICAL FIELD

The present technique relates to a biological sample analysis system, a biological sample analysis method, and a program.

### BACKGROUND ART

For example, a particle group such as a cell, a microorganism, or a liposome is labeled with a fluorescent pigment, and the intensity and/or pattern of fluorescence generated from the fluorescent pigment excited by irradiating each particle of the particle group with light is measured to measure the characteristics of the particles. As a typical example of such a method, a flow cytometry can be cited.

The flow cytometry analyzes multiple particles one by one by irradiating particles flowing in a flow channel in a line with laser light having a specific wavelength and detecting fluorescence and/or scattered light emitted from each particle. More specifically, in the flow cytometry, light detected by a photodetector is converted into an electric signal and digitized, and statistical analysis is performed to determine the characteristics of individual particles, for example, the size, the structure, and the like.

Before analysis of a biological sample by a system using the flow cytometry is executed, for example, calibration of a laser light source, a photodetector, or the like is performed. Some methods related to the calibration have been proposed so far, and, for example, PTL 1 discloses a fine particle measurement apparatus that includes a detection unit for detecting light from a fluorescent reference particle emitting fluorescence having a predetermined wavelength range, and an information processing unit for specifying a relation between a voltage application coefficient corresponding to the characteristic amount of a predetermined output pulse and a control signal of the detection unit on the basis of the characteristic amount of an output pulse detected by the detection unit and the control signal of the detection unit when the characteristic amount of the output pulse is detected, and the characteristic amount of the output pulse is a value dependent on the control signal of the detection unit.

### CITATION LIST

### Patent Literature

### [PTL 1]

Japanese Patent Laid-open No. 2020-122803

### SUMMARY

### Technical Problem

Here, in addition to the calibration of the laser light source, the photodetector, or the like, for the purpose of another adjustment of sorting performance or the like, it is required for convenience in some cases to perform calibration or adjustment processing by using sample beads for adjustment containing different kinds of beads. In this case, it is necessary to acquire only data related to particles having predetermined characteristics according to the application.

Therefore, a main object of the present technique is to provide a technique for specifying particles having predetermined characteristics from multiple kinds of particles having different characteristics.

### Solution to Problem

First, the present technique provides a biological sample analysis system including a detection unit that detects light generated by light irradiation to particles, and an information processing unit that processes light intensity data detected by the detection unit, in which the information processing unit executes processing of specifying particles having predetermined characteristics from multiple kinds of particles having different characteristics on the basis of the light intensity data generated by light irradiation to a sample containing particle groups including the multiple kinds of particles having different characteristics.

In addition, the present technique also provides a biological sample analysis method including a detection step of detecting light generated by light irradiation to particles, and an information processing step of processing light intensity data detected in the detection step, in which, in the information processing step, processing of specifying particles having predetermined characteristics from multiple kinds of particles having different characteristics on the basis of the light intensity data generated by light irradiation to a sample containing particle groups including the multiple kinds of particles having different characteristics is executed.

Further, the present technique also provides a program to execute processing of detecting light generated by light irradiation to particles, processing detected light intensity data, and specifying particles having predetermined characteristics from multiple kinds of particles having different characteristics on the basis of the light intensity data generated by light irradiation to a sample containing particle groups including the multiple kinds of particles having different characteristics.

### BRIEF DESCRIPTION OF DRAWINGS

FIG. 1 is a diagram for depicting a difference between digital adjustment and analog adjustment.

FIG. 2 is a diagram for schematically depicting a configuration example of a biological sample analysis system 6100 of the present embodiment.

FIG. 3 is a flowchart for depicting a processing example 1 (flow of specifying particles having predetermined characteristics) in an information processing unit 6103.

FIG. 4 is a diagram for depicting a two-parameter histogram (cytogram) in which the X-axis represents forward scattered light (FSC) and the Y-axis represents back scattered light (BSC).

FIG. 5 is a diagram for depicting a configuration of an optical system configuring a light irradiation unit 6101 and a detection unit 6102 in the biological sample analysis system 6100.

FIG. 6 is a conceptual diagram for depicting an MPPC module.

FIG. 7 is a flowchart for depicting a processing example 2 (MPPC output adjustment flow) in the information processing unit 6103.

### DESCRIPTION OF EMBODIMENTS

Hereinafter, preferred modes for carrying out the present technique will be described. It should be noted that embodiments to be described below depict representative embodiments of the present technique, and the scope of the present technique is not limited to these embodiments. It should be noted that the present technique will be described in the following order.
1. Outline of present technique
2. First embodiment (biological sample analysis system 6100)
(1) Configuration example of biological sample analysis system 6100
(2) Processing example 1 (flow of specifying particles having predetermined characteristics) in information processing unit 6103
(3) Processing example 2 (MPPC output adjustment flow) in information processing unit 6103
3. Second embodiment (biological sample analysis method)
4. Third embodiment (program)

### 1. Outline of Present Technique

In biological sample analysis systems using a flow cytometry, a photodiode such as an MPPC (Multi-Pixel Photon Counter) is employed as a photodetector in some cases. In these biological sample analysis systems, individual sensitivity differences and sensitivity differences with the passage of time caused by the photodetector occur in some cases. For this reason, there is a problem that the output levels of the photodetectors differ between apparatuses or within apparatuses even when the settings are the same and the sensitivity differs.

Therefore, there is a method of adjusting the sensitivity difference by using Align Check Beads or the like. However, different kinds of beads are necessary for adjustment for another application (for example, adjustment of sorting performance or the like), and the use of sample beads for adjustment containing two or more kinds of beads is required for convenience in some cases. Therefore, in the case where there are two or more kinds of beads, there is a demand for a new algorithm that acquires only the events of beads having predetermined characteristics.

In addition, in sensitivity calibration, as a method of calibrating apparent sensitivity, there is, for example, a digitally adjusting method. However, it is difficult to desire an approximation of the S/N in this method. On the other hand, there is analog adjustment by changing a circuit gain or changing an internal gain of a device, and in this case, it is possible to desire even an approximation of the S/N.

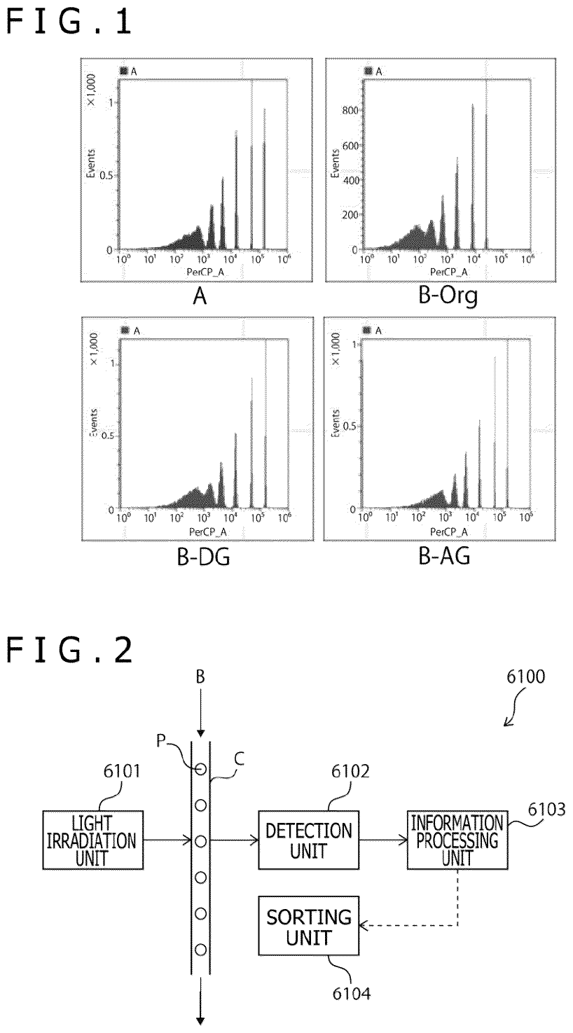

Here, the difference between the digital adjustment and the analog adjustment is depicted in FIG. 1. In FIG. 1, as an initial assumption, the levels of A and B-Org do not match. Thus, the diagram obtained by digitally adjusting the levels with respect to B-Org is B-DG (=Digital Gain), and the diagram obtained by analogically adjusting the levels is B-AG (=Analog Gain). It can be understood that B-AG has a higher degree of approximation to A than B-DG, especially, at low levels.

Therefore, in the present technique, means for specifying particles having predetermined characteristics from multiple kinds of particles having different characteristics will be described. Then, as one of analog adjustment methods, a method of calibrating the sensitivity by conducting measurement using sample beads and adjusting the output level of fluorescence with a Vop that is the operation voltage of an MPPC or the like. Thus, in addition to matching the sensitivity, it is possible to desire even an approximation of levels obtained at low levels and high levels.

### 2. First Embodiment (Biological Sample Analysis System 6100)

### (1) Configuration Example of Biological Sample Analysis System 6100

FIG. 2 schematically depicts a configuration example of a biological sample analysis system 6100 of the present embodiment. The biological sample analysis system 6100 depicted in FIG. 2 includes a light irradiation unit 6101 for irradiating a biological sample B flowing through a flow channel C with light, a detection unit 6102 for detecting light generated by irradiating the biological sample B with light, and an information processing unit 6103 for processing information related to the light detected by the detection unit 6102. As examples of the biological sample analysis system 6100, a flow cytometer and an imaging cytometer can be cited. The biological sample analysis system 6100 may include a sorting unit 6104 that sorts the target particles from particles P in the biological sample B. As an example of the biological sample analysis system 6100 including the sorting unit 6104, a cell sorter can be cited.

### Biological Sample B

The biological sample B may be a liquid sample containing biological particles. The biological particles are, for example, cells or acellular biological particles. The cells may be living cells, and as more specific examples, blood cells such as red blood cells and white blood cells, and germ cells such as sperm and fertilized eggs can be cited. In addition, the cells may be extracted directly from a specimen such as whole blood, or may be cultured cells acquired after culture. As the acellular biological particles, extracellular vesicles, particularly, exosomes, microvesicles, and the like can be cited. The biological particles may be labeled with one or more labeling substances (for example, pigments (in particular, fluorescent pigments), fluorescent pigment labeled antibodies, and the like). It should be noted that particles other than the biological particles may be analyzed by the biological sample analysis system 6100 of the present technique, and beads or the like may be analyzed for calibration or the like.

### Flow Channel C

The flow channel C is configured such that the biological sample B flows. In particular, the flow channel C can be configured to form a flow in which the particles P contained in the biological sample B are arranged substantially in a line. A flow path structure including the flow channel C may be designed so as to form a laminar flow. In particular, the flow channel structure is designed such that a laminar flow in which a flow of the biological sample B (sample flow) is enveloped by a flow of a sheath liquid is formed. The design of the flow channel structure may be appropriately selected by a person skilled in the art, and known designs may be employed. The flow channel C may be formed in a flow channel structure such as a microchip (a chip having a flow channel on a micrometer order) or a flow cell. The width of the flow channel C is 1 mm or less, and in particular, may be 10 μm or more and 1 mm or less. The flow channel C and the flow channel structure including the same may include a material such as plastic or glass.

The biological sample analysis system 6100 of the present technique can be configured such that the biological sample B flowing in the flow channel C, particularly the particles P in the biological sample B, are irradiated with light from the light irradiation unit 6101. The biological sample analysis system 6100 of the present technique may be configured such that an interrogation point of light to the biological sample B is in the flow channel structure in which the flow channel C is formed or the interrogation point of the light is outside the flow channel structure. As an example of the former, a configuration in which the flow channel C in a microchip or a flow cell is irradiated with the light can be cited. As an example of the latter, the particles P after exiting the flow channel structure (in particular, a nozzle portion thereof) may be irradiated with the light, and, for example, a jet-in-air flow cytometer can be cited.

### Light Irradiation Unit 6101

The light irradiation unit 6101 includes a light source unit for emitting light and a light guide optical system for guiding the light to the interrogation point. The light source unit includes one or more light sources. The kind of light source is, for example, a laser light source or an LED. The wavelength of light emitted from each light source may be the wavelength of any one of ultraviolet light, visible light, or infrared light. The light guide optical system includes, for example, an optical component such as a beam splitter group, a mirror group, or an optical fiber. In addition, the light guide optical system may include a lens group for condensing light, and can include, for example, an objective lens. One or more interrogation points at which light intersects the biological sample B may be provided. In addition, the light irradiation unit 6101 may be configured to condense light emitted from one or more different light sources to a single interrogation point.

### Detection Unit 6102

The detection unit 6102 is provided with at least one photodetector for detecting light generated by irradiation of light to the particles P. The light to be detected is, for example, fluorescence or scattered light (for example, any one or more of forward scattered light, back scattered light, and side scattered light). Each photodetector includes one or more light receiving elements, and has, for example, a light receiving element array. Each photodetector may include one or more PMTs (photomultiplier tubes) and/or photodiodes such as APDs and MPPCs as light receiving elements. The photodetector includes, for example, a PMT array in which multiple PMTs is arranged in a one-dimensional direction. In addition, the detection unit 6102 may include an imaging element such as a CCD or a CMOS. The detection unit 6102 can acquire images (for example, a bright field image, a dark field image, a fluorescent image, and the like) of the particles P by the imaging element.

The detection unit 6102 includes a detection optical system that causes light of a predetermined detection wavelength to reach a corresponding photodetector. The detection optical system includes a spectral unit such as a prism or a diffraction grating, or a wavelength separation unit such as a dichroic mirror or an optical filter. The detection optical system is configured such that, for example, light generated by light irradiation to the particles P is divided and the divided light is detected by multiple photodetectors that is larger in number than the number of fluorescent pigments with which the particles P are labeled. A flow cytometer including such a detection optical system is referred to as a spectrum flow cytometer. In addition, the detection optical system is configured, for example, to separate light corresponding to the fluorescence wavelength range of a specific fluorescent pigment from light generated by light irradiation to the particles P and to cause a corresponding photodetector to detect the separated light.

In addition, the detection unit 6102 can include a signal processing unit that converts an electrical signal obtained by the photodetector into a digital signal. The signal processing unit may include an A/D converter as an apparatus for performing the conversion. The digital signal obtained by the conversion by the signal processing unit can be transmitted to the information processing unit 6103. The digital signal can be handled as data related to light (hereinafter, also referred to as “light data”) by the information processing unit 6103. The light data may be, for example, optical data including fluorescence data. More specifically, the light data may be light intensity data, and the light intensity may be light intensity data (for example, characteristic amounts such as an area, a height, and a width) of light including fluorescence.

### Information Processing Unit 6103

The information processing unit 6103 includes, for example, a processing unit for executing processing of various kinds of data (for example, light data and the like) and a storage unit for storing various kinds of data. In the case where the light data corresponding to the fluorescent pigment is acquired from the detection unit 6102, the processing unit can perform fluorescence leakage correction (compensation processing) on the light intensity data. In addition, in the case of a spectrum flow cytometer, the processing unit executes fluorescence separation processing on the light data to acquire the light intensity data corresponding to the fluorescent pigment. The fluorescence separation processing may be performed according to the unmixing method described in, for example, Japanese Patent Laid-open No. 2011-232259. In the case where the detection unit 6102 includes an imaging element, the processing unit may acquire form information of the particles P on the basis of an image acquired by the imaging element. The storage unit may be configured to be capable of storing the acquired light data. The storage unit may further be configured to be capable of storing spectral reference data used in the unmixing processing.

In addition, in the case where the biological sample analysis system 6100 includes the sorting unit 6104 to be described later, the information processing unit 6103 can determine whether or not to sort the particles P, on the basis of the light data and/or the form information. Then, on the basis of the result of the determination, the information processing unit 6103 controls the sorting unit 6104, and the sorting unit 6104 can sort the target particles.

The information processing unit 6103 may be configured to be capable of outputting various kinds of data (for example, light data, images, or the like). For example, the information processing unit 6103 can output various kinds of generated data (for example, histograms, spectrum plots, or the like) on the basis of the light data. In addition, the information processing unit 6103 may be configured to be capable of accepting input of various kinds of data, and accepts, for example, gating processing on a plot by a user. The information processing unit 6103 can include an output unit (for example, a display, a printer, and the like) or an input unit (for example, a keyboards, a barcode reader, a camera, a tablet terminal, and the like) for executing the output or the input.

The information processing unit 6103 may be configured as a general-purpose computer, and may be configured as, for example, an information processing apparatus including a CPU, a RAM, and a ROM. The information processing unit 6103 may be included inside a housing in which the light irradiation unit 6101 and the detection unit 6102 are provided, or may be provided outside the housing. In addition, various kinds of processing or functions by the information processing unit 6103 may be realized by a server computer or a cloud connected via a network.

### Sorting Unit 6104

The sorting unit 6104 sorts the target particles from the particles P in the biological sample B according to the determination result on the basis of the light data and/or the form information by the information processing unit 6103. The sorting method may be a method in which droplets containing the particles P are generated by vibration, an electric charge is applied to the droplets to be sorted, and the traveling direction of the droplets is controlled by electrodes. The sorting method may be a method in which sorting is performed by controlling the traveling direction of the particles P in the flow channel structure. The flow channel structure is provided with a control mechanism by, for example, pressure (injection or suction) or an electric charge. As an example of the flow channel structure, a chip (for example, a chip described in Japanese Patent Laid-open No. 2020-76736) which has a flow channel structure in which the flow channel C branches into a recovery flow channel and a waste liquid flow channel on the downstream side and in which specific particles P are recovered into the recovery flow channel can be cited.

### (2) Processing Example 1 (Flow of Specifying Particles Having Predetermined Characteristics) in Information Processing Unit 6103

In the present embodiment, the information processing unit 6103 executes processing of specifying particles having predetermined characteristics from multiple kinds of particles having different characteristics on the basis of the light intensity data generated by light irradiation to a sample containing particle groups including the multiple kinds of particles having different characteristics. It should be noted that the “characteristics” referred to herein indicate the sizes of the particles, the structures (for example, the shape and the like) of the particles, the density of the particles, and the like.

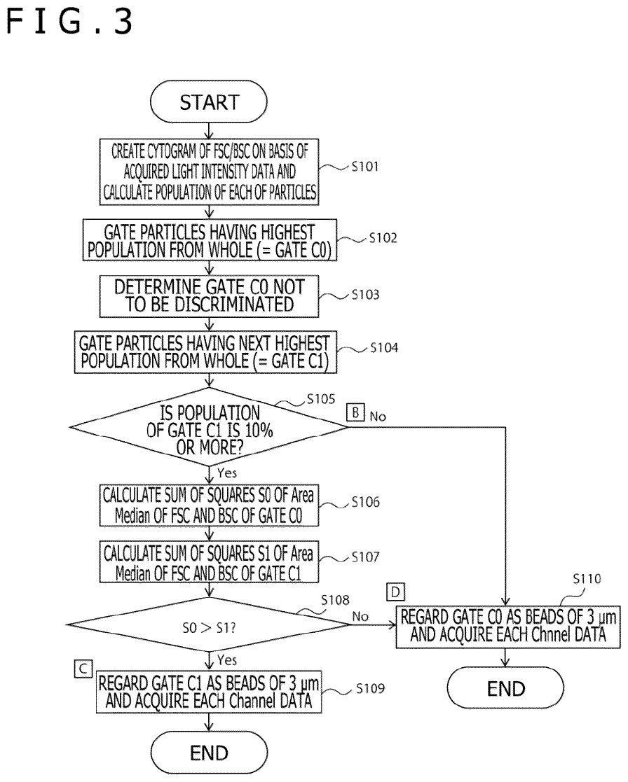

FIG. 3 is a flowchart for depicting a processing example 1 (flow of specifying particles having predetermined characteristics) in the information processing unit 6103. Hereinafter, the processing example will be described in detail with reference to the flowchart depicted in FIG. 3. Specifically, the flow is to specify sample beads of a predetermined size from a sample containing particle groups including beads of 3 μm and beads of 10 μm.

In the present embodiment, processing of acquiring the light intensity data from multiple kinds of predetermined sample beads having different characteristics is also executed. That is, a flow cytometry is executed on the predetermined sample beads prior to Step S101. The predetermined sample beads may be, for example, beads capable of obtaining fluorescence in a wavelength range of 400 to 800 nm, and it is preferable to use sample beads having a generally high fluorescence level. As an example of such sample beads, Automatic Setup Beads (manufactured by Sony Group Corporation) can be cited, but the present embodiment is not limited thereto.

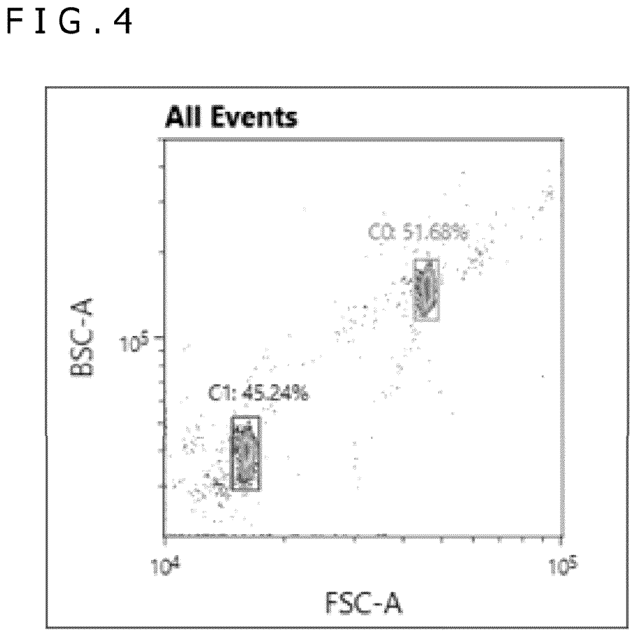

First, in Step S101, the information processing unit 6103 creates a histogram on the basis of the light intensity data acquired by light irradiation to a sample containing particle groups including multiple kinds of particles having different characteristics. Specifically, the information processing unit 6103 uses the area of the pulse as the light intensity data, and as depicted in FIG. 4, creates a two-parameter histogram (cytogram) in which the X-axis represents forward scattered light (FSC) and the Y-axis represents back scattered light (BSC). However, the present embodiment is not limited thereto, and any two or more kinds selected from groups including forward scattered light, side scattered light (SSC), and back scattered light may be selected as the light, and any one kind of characteristic amount selected from groups including the pulse height, the pulse width, and the pulse area may be used as the light intensity data. In Step S101, the population of each of the particles is further calculated from the created histogram.

Next, in Step S102, the information processing unit 6103 gates the particles having the highest population (see C0: 51.68% in FIG. 4) from the whole on the basis of the calculated population. Then, in Step S103, the information processing unit 6103 determines the gate C0 not to be discriminated.

Next, in Step S104, the information processing unit 6103 gates the particles having the next highest population (see C1: 45.24% in FIG. 4) from the whole in a state where the gate C0 is determined not to be discriminated. At this time, in Step S105, the information processing unit 6103 determines whether or not the population of the particles (gate C1) determined to be discriminated satisfies a predetermined condition. Specifically, for example, a predetermined condition of whether or not the population of the gate C1 is 10% or more is provided in advance, and the information processing unit 6103 determines whether or not the condition is satisfied.

Next, in Step S105, in the case where the population of the gate C1 satisfies a predetermined condition, the information processing unit 6103 calculates each parameter S in the particles (gate C1) determined to be discriminated and the particles (gate C0) determined not to be discriminated on the basis of the light intensity data in Steps S106 and S107. Specifically, the parameter S can be, for example, the sum of squares of the areas of the pulses of the forward scattered light and the back scattered light. It should be noted that, as the “areas of the pulses” here, the median value (Median) or the mean value (Mean) of the areas of the pulses can be used, but it is preferable to use the median value (Area Median) of the areas of the pulses in the present embodiment.

Next, in Step S108, the information processing unit 6103 compares a parameter S0 calculated on the basis of the gate C0 with a parameter S1 calculated on the basis of the gate C1, and in the case where S0>S1 is satisfied, the gate C1 is regarded as beads of 3 μm, and each channel data is acquired in Step S109. On the other hand, in the case where S0≤S1 is satisfied in Step S108, the gate C0 is regarded as beads of 3 μm, and each channel data is acquired in Step S110.

In the case where the population of the gate C1 does not satisfy the predetermined condition in Step S105, the information processing unit 6103 regards the gate C0 as beads of 3 μm and acquires each channel data in Step S110. In this case (see “B” in FIG. 3), it is assumed that beads of 10 μm are precipitated and almost not detected. That is, the gate C0 is a singlet of beads of 3 μm, and the gate C1 is debris, a doublet or more of beads of 3 μm, or a singlet of beads 10 μm. Therefore, in Step S110, the gate C0 is employed as a singlet of beads of 3 μm.

It should be noted that, in the case where it is desired to acquire beads of 10 μm, it is sufficient that the gate C0 in “C” of FIG. 3 and the gate C1 in “D” of FIG. 3 are regarded as beads of 10 μm.

In addition, in the case where the kinds of particles are increased, a corresponding flow can be appropriately constructed by applying the flow described above by comparing between the populations or the parameters S.

By using the flow described above, in particle groups including multiple kinds of particles having different characteristics, particles having predetermined characteristics can be specified by discrimination using a histogram, a population, a statistical value, or the like, and an event of the particles having the predetermined characteristics can be acquired. Thus, particle groups including multiple kinds of particles having different characteristics can be used for calibration or adjustment processing, and, for example, a sample mixed with particles used for another application such as sorting performance can be used for adjustment.

### (3) Processing Example 2 (MPPC Output Adjustment Flow) in Information Processing Unit 6103

In the present embodiment, the information processing unit 6103 acquires the characteristic amount of the output pulse of the detection unit on the basis of the light intensity data of the specified particles having the predetermined characteristics. In the present embodiment, it is assumed that an MPPC is employed as the photodetector. The present embodiment is suitable for solving the problem described in “1. Outline of present technique” that occurs in the case where the detection unit 6102 includes such a light receiving element.

FIG. 5 is a diagram for depicting a configuration of an optical system configuring the light irradiation unit 6101 and the detection unit 6102 in the biological sample analysis system 6100. An optical system 350 depicted in FIG. 5 includes a laser light generation unit 351 for generating laser light with which a detection region is irradiated. The laser light generation unit 351 includes, for example, laser light sources 352-1, 352-2, and 352-3, and also includes mirror groups 353-1, 353-2, and 353-3 for synthesizing laser light emitted from these laser light sources. The laser light sources 352-1, 352-2, and 352-3 may emit laser light having wavelengths that are different from each other. By arranging the three laser light sources and the three mirrors as depicted in FIG. 5, the laser light emitted to the particles P is synthesized. The synthesized laser light passes through a mirror 342, is reflected by a mirror 354, passes through a shutter 355, and enters an objective lens 356. The laser light is condensed by the objective lens 356 and reaches, for example, a detection region formed on a microchip 150. The particles P flowing through the detection region are irradiated with the laser light to generate fluorescence and scattered light.

As described above, in the optical system 350 depicted in FIG. 5, the laser light generation unit 351, the mirrors 342 and 354, and the objective lens 356 are included as constitutional elements of the light irradiation unit 6101.

The optical system 350 includes a fluorescence detector (FL) 357 for detecting the fluorescence. The fluorescence enters the objective lens 356 and is condensed by the objective lens 356. The fluorescence condensed by the objective lens 356 passes through the shutter 355, passes through the mirror 354, and is detected by the fluorescence detector 357. The optical system 350 includes a scattered light detector 358-3 for detecting back scattered light among the scattered light. The back scattered light enters the objective lens 356 and is condensed by the objective lens 356. The back scattered light condensed by the objective lens 356 passes through the shutter 355, is reflected by the mirror 354, is further reflected by the mirror 342, and is detected by the scattered light detector 358-3. The scattered light detector 358-3 detects light having the same wavelength as that of the laser light emitted from the laser light source 352-3. The optical system 350 also includes scattered light detectors 358-1 and 358-2 for detecting forward scattered light among the scattered light. The forward scattered light enters an objective lens 359 and is condensed by the objective lens 359. The forward scattered light condensed by the objective lens 359 passes through a mirror 343, and is separated by a mirror 360 into light having the same wavelength as that of the laser light emitted from the laser light source 352-1 and light having the same wavelength as that of the laser light emitted from the laser light source 352-2. The mirror 360 may be, for example, a half mirror, and has optical characteristics that reflect the former light and cause the latter light to pass through. The former light is reflected by a mirror 361 and detected by the scattered light detector 358-1. The latter light is detected by the scattered light detector 358-2.

As described above, in the optical system 350 depicted in FIG. 5, the fluorescence detector 357 for detecting the fluorescence generated by irradiation with laser light, the scattered light detectors 358-1, 358-2, and 358-3 for detecting the scattered light generated by the irradiation, the mirror group for allowing the fluorescence and/or scattered light to pass through or to reflect, and the objective lenses 356 and 359 are included as the constitutional elements of the detection unit 6102.

The optical system 350 further includes an illumination apparatus 370 and an imaging element 371. The illumination apparatus 370 irradiates the microchip 150 with illumination light necessary for imaging the flow channel. The illumination light emitted from the illumination apparatus 370 is reflected by a mirror 344 and the mirror 343, passes through the objective lens 359, and reaches the microchip 150. The flow channel of the microchip 150 illuminated by the illumination light is imaged by the imaging element 371 through the objective lens 359. That is, the illumination apparatus 370 and the imaging element 371 are configured to image the flow channel through the objective lens 359.

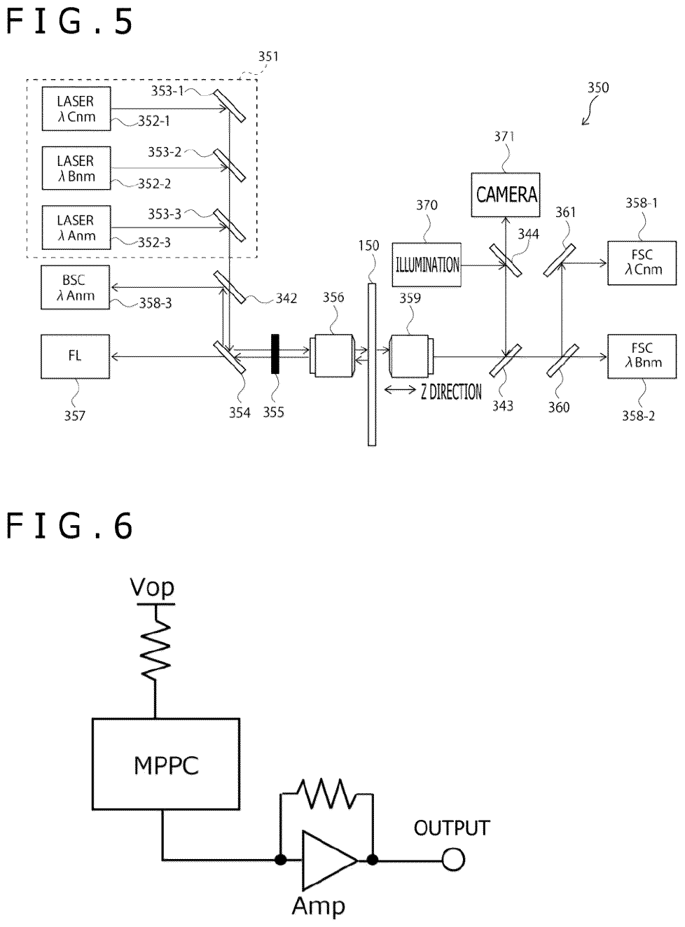

In the present embodiment, it is assumed that an MPPC is particularly employed as the fluorescence detector 357 in the optical system 350 depicted in FIG. 5. FIG. 6 is a conceptual diagram for depicting an MPPC module. The MPPC (Multi-Pixel Photon Counter) is one of SiPMs and includes multiple APDs (avalanche photodiodes) arranged in an array. The unit of each APD is also called a pixel. The MPPC detects photons entering all the pixels within the detection time. As depicted in FIG. 6, the MPPC module is mounted with an amplifier and a high-voltage current circuit in addition to the MPPC. In such an MPPC module, in the case where the amount of incident light to the MPPC is less than the saturation level and is constant, when the Vop changes, the amount of current flowing through the MPPC changes, and the output changes.

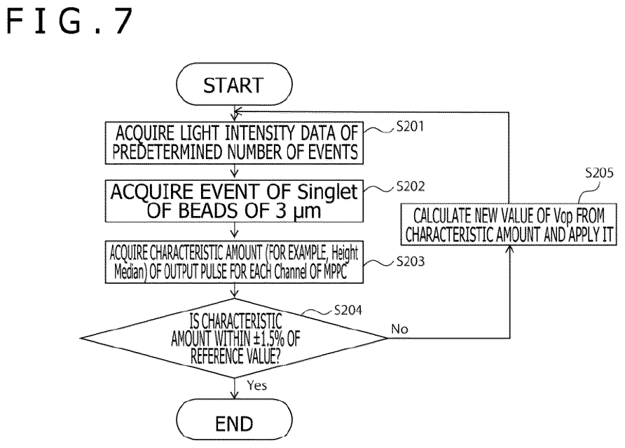

FIG. 7 is a flowchart for depicting a processing example 2 (MPPC output adjustment flow) in the information processing unit 6103. Hereinafter, the processing example will be described in detail with reference to the flowchart depicted in FIG. 7. It should be noted that the processing example may be performed at an apparatus setting stage before analysis processing of the biological sample by the biological sample analysis system 6100 is started, and may be performed, for example, at a QC (Quality Control) stage. In addition, the processing example may be performed in the middle of the analysis processing of the biological sample by the biological sample analysis system.

It should be noted that the flowchart depicted in FIG. 7 functions even in the case where sample beads including only beads having a predetermined size such as Align Check Beads (manufactured by Sony Group Corporation) are used instead of Automatic Setup Beads.

First, in Step S201, the information processing unit 6103 executes processing of acquiring the light intensity data of a predetermined number of events using sample beads such as Automatic Setup Beads. The predetermined number of events acquired here may be, for example, from 500 events to 10,000 events, preferably from 1,000 events to 7,000 events, and more preferably from 2,000 events to 5,000 events. The biological sample analysis system 6100 executes a flow cytometry for the acquisition.

Next, in Step S202, the information processing unit 6103 acquires an event of a singlet of beads of 3 μm according to the above-described “(2) Processing example 1 (flow of specifying particles having predetermined characteristics) in information processing unit 6103.” Next, in Step S203, the information processing unit 6103 acquires the characteristic amount of the output pulse for each channel of the MPPC from the acquired event. As the characteristic amount of the output pulse, the height of the output pulse or the area of the output pulse can be cited. A median value (Median) or a mean value (Mean) can be used for these values, but it is preferable to use a median value (Height Median) of the height of the output pulse in the present embodiment.

Next, in Step S204, the information processing unit 6103 determines whether or not the characteristic amount of the output pulse is within a range based on a reference value. Specifically, for example, it is determined whether or not the median value of the height of the output pulse acquired in Step S203 is within ±1.5% of the reference value.

In Step S204, in the case where the characteristic amount of the output pulse is within ±1.5% of the reference value, the information processing unit 6103 terminates the adjustment of the detection unit. On the other hand, in the case where the characteristic amount of the output pulse exceeds ±1.5% of the reference value, the information processing unit 6103 calculates a new value of the Vop on the basis of the characteristic amount (specifically, for example, the median value of the height of the output pulse acquired in Step S203) of the output pulse and applies it. That is, the output is adjusted by changing the Vop and changing the amount of current flowing through the MPPC on the basis of the median value of the height of the output pulse acquired in Step S203. Then, when the application is completed, the flow returns to Step S201 again.

It should be noted that, in the present embodiment, in the case where the detection unit 6102 includes multiple light receiving elements (that is, multiple MPPCs), each light receiving element may be set as one fluorescence channel. In this case, the information processing unit 6103 may acquire the light intensity data for each of one or more fluorescence channels in Step S201. In addition, in the present embodiment, the processing of the subsequent Steps S202 to S205 may be performed for each fluorescence channel.

It should be noted that the reference value and the determination criterion may be appropriately changed for each channel according to the kinds of particles. The kinds of particles include the kinds of sample beads (for example, beads of only a single size, sample beads having multiple sizes, or the like), lots of sample beads, the date of manufacture of sample beads, and the like.

Data of the reference value and the determination criterion for each kind of particle is preferably input to the biological sample analysis system through, for example, the input unit (for example, a keyboard, a barcode reader, a camera, a tablet terminal, and the like) of the information processing unit 6103. Specifically, data (for example, numbers and the like) may be input using a keyboard, or data attached to a one-dimensional bar code or a two-dimensional bar code may be read by a bar code reader or a camera. In addition, data may also be captured in a server or a cloud system connected through a network. In the case where a number, a one-dimensional bar code, a two-dimensional bar code, or the like is used, it is preferable that these pieces of information be given to each kind of the particle.

It should be noted that, in the above-described flow, when the MPPC is another detector and the Vop is a parameter for operating an analog gain, the above-described output adjustment flow can be generalized.

By using the above-described flow, the Vop of the MPPC can be adjusted on the basis of the output from the sample beads, and the output values as the apparatus can be made uniform. Thus, even in the case of two or more apparatuses or aging apparatuses, the sensitivity can be made uniform, and the same output can be obtained if the samples are the same.

### 3. Second Embodiment (Biological Sample Analysis Method)

A biological sample analysis method according to the present embodiment includes a detection step of detecting light generated by light irradiation to particles, and an information processing step of processing light intensity data detected in the detection step, and in the information processing step, processing of specifying particles having predetermined characteristics from multiple kinds of particles having different characteristics is executed on the basis of the light intensity data generated by light irradiation to a sample containing particle groups including the multiple kinds of particles having different characteristics.

Since the processing performed in the detection step is similar to the processing performed in the detection unit 6102 and the processing performed in the information processing step is similar to the processing performed in the information processing unit 6103, the description thereof is omitted here.

### 4. Third Embodiment (Program)

A program according to the present embodiment detects light generated by light irradiation to particles and processes the detected light intensity data, and executes processing of specifying particles having predetermined characteristics from multiple kinds of particles having different characteristics on the basis of the light intensity data generated by light irradiation to a sample containing particle groups including the multiple kinds of particles having different characteristics.

Since the above-described processing is similar to the processing performed in the detection unit 6102 and the information processing unit 6103, the description thereof is omitted here.

The program according to the present embodiment can function by being stored in hardware resources including a general-purpose computer, a control unit including a CPU and the like, and a recording medium (for example, a non-volatile memory (for example, a USB memory or the like), an HDD, a CD, or the like). It should be noted that the function may be realized by a server or a cloud system connected through a network.

It should be noted that the present technique can also employ the following configurations.
[1]

A biological sample analysis system including:
a detection unit that detects light generated by light irradiation to particles; and
an information processing unit that processes light intensity data detected by the detection unit,
in which the information processing unit executes processing of specifying particles having predetermined characteristics from multiple kinds of particles having different characteristics on the basis of the light intensity data generated by light irradiation to a sample containing particle groups including the multiple kinds of particles having different characteristics.
[2]

The biological sample analysis system according to [1],
in which the information processing unit creates a histogram on the basis of the light intensity data and calculates a population of each of the particles.
[3]

The biological sample analysis system according to [2],
in which the particles having the predetermined characteristics are specified on the basis of the calculated population.
[4]

The biological sample analysis system according to [3],
in which the information processing unit determines particles having the highest population not to be discriminated.
[5]

The biological sample analysis system according to [4],
in which the information processing unit determines whether or not the population of the particles determined to be discriminated satisfies a predetermined condition.
[6]

The biological sample analysis system according to [5],
in which, in a case where the population satisfies the predetermined condition, the information processing unit compares parameters calculated on the basis of the light intensity data with each other in the particles determined to be discriminated and the particles determined not to be discriminated, and specifies the particles having the predetermined characteristics.
[7]

The biological sample analysis system according to [6],
in which the light includes any two or more kinds selected from groups including forward scattered light, side scattered light, and back scattered light.
[8]

The biological sample analysis system according to [6] or [7],
in which the light intensity data includes any one kind of characteristic amount selected from groups including a pulse height, a pulse width, and a pulse area.
[9]

The biological sample analysis system according to any one of [6] to [8],
in which the parameter is the sum of squares of pulse areas of forward scattered light and back scattered light.
[10]

The biological sample analysis system according to [6],
in which, in a case where the population does not satisfy the predetermined condition, the information processing unit specifies the particles determined not to be discriminated as the particles having the predetermined characteristics.
[11]

The biological sample analysis system according to any one of [1] to [10],
in which the detection unit includes one or more MPPCs as detectors for detecting the light.
[12]

The biological sample analysis system according to any one of [1] to [11],
in which the information processing unit acquires a characteristic amount of an output pulse of the detection unit on the basis of the light intensity data of the specified particles having the predetermined characteristics.
[13]

The biological sample analysis system according to [12],
in which the characteristic amount of the output pulse includes an output pulse height or an output pulse area.
[14]

The biological sample analysis system according to [12] or [13],
in which the information processing unit determines whether or not the characteristic amount of the output pulse is within a range based on a reference value.
[15]

The biological sample analysis system according to [14],
in which, in a case where the characteristic amount of the output pulse is within the range based on the reference value, the information processing unit controls the detection unit on the basis of the characteristic amount of the output pulse.
[16]

The biological sample analysis system according to [14] or [15],
in which the information processing unit changes the reference value according to the kinds of particles.
[17]

The biological sample analysis system according to any one of [1] to [16], further including:
a light irradiation unit for irradiating a biological sample with light.
[18]

The biological sample analysis system according to any one of [1] to [17], further including:
a sorting unit for sorting target particles from particles in a biological sample on the basis of the light intensity data.
[19]

A biological sample analysis method including:
a detection step of detecting light generated by light irradiation to particles; and
an information processing step of processing light intensity data detected in the detection step,
in which, in the information processing step, processing of specifying particles having predetermined characteristics from multiple kinds of particles having different characteristics on the basis of the light intensity data generated by light irradiation to a sample containing particle groups including the multiple kinds of particles having different characteristics is executed.
[20]

A program to execute processing of detecting light generated by light irradiation to particles, processing detected light intensity data, and specifying particles having predetermined characteristics from multiple kinds of particles having different characteristics on the basis of the light intensity data generated by light irradiation to a sample containing particle groups including the multiple kinds of particles having different characteristics.

### REFERENCE SIGNS LIST

6100: Biological sample analysis system
6101: Light irradiation unit
6102: Detection unit
6103: Information processing unit
6104: Sorting unit
B: Biological sample
C: Flow channel
P: Particle

1. A biological sample analysis system comprising:
a detection unit that detects light generated by light irradiation to particles; and
an information processing unit that processes light intensity data detected by the detection unit,
wherein the information processing unit executes processing of specifying particles having predetermined characteristics from multiple kinds of particles having different characteristics on a basis of the light intensity data generated by light irradiation to a sample containing particle groups including the multiple kinds of particles having different characteristics.

2. The biological sample analysis system according to claim 1,
wherein the information processing unit creates a histogram on the basis of the light intensity data and calculates a population of each of the particles.

3. The biological sample analysis system according to claim 2,
wherein the particles having the predetermined characteristics are specified on a basis of the calculated population.

4. The biological sample analysis system according to claim 3,
wherein the information processing unit determines particles having a highest population not to be discriminated.

5. The biological sample analysis system according to claim 4,
wherein the information processing unit determines whether or not the population of the particles determined to be discriminated satisfies a predetermined condition.

6. The biological sample analysis system according to claim 5,
Wherein, in a case where the population satisfies the predetermined condition, the information processing unit compares parameters calculated on the basis of the light intensity data with each other in the particles determined to be discriminated and the particles determined not to be discriminated, and specifies the particles having the predetermined characteristics.

7. The biological sample analysis system according to claim 6,
wherein the light includes any two or more kinds selected from groups including forward scattered light, side scattered light, and back scattered light.

8. The biological sample analysis system according to claim 6,
wherein the light intensity data includes any one kind of characteristic amount selected from groups including a pulse height, a pulse width, and a pulse area.

9. The biological sample analysis system according to claim 6,
wherein the parameter is a sum of squares of pulse areas of forward scattered light and back scattered light.

10. The biological sample analysis system according to claim 6,
Wherein, in a case where the population does not satisfy the predetermined condition, the information processing unit specifies the particles determined not to be discriminated as the particles having the predetermined characteristics.

11. The biological sample analysis system according to claim 1,
wherein the detection unit includes one or more MPPCs as detectors for detecting the light.

12. The biological sample analysis system according to claim 1,
wherein the information processing unit acquires a characteristic amount of an output pulse of the detection unit on a basis of the light intensity data of the specified particles having the predetermined characteristics.

13. The biological sample analysis system according to claim 12,
wherein the characteristic amount of the output pulse includes an output pulse height or an output pulse area.

14. The biological sample analysis system according to claim 12,
wherein the information processing unit determines whether or not the characteristic amount of the output pulse is within a range based on a reference value.

15. The biological sample analysis system according to claim 14,
Wherein, in a case where the characteristic amount of the output pulse is within the range based on the reference value, the information processing unit controls the detection unit on a basis of the characteristic amount of the output pulse.

16. The biological sample analysis system according to claim 14,
wherein the information processing unit changes the reference value according to the kinds of particles.

17. The biological sample analysis system according to claim 1, further comprising:
a light irradiation unit for irradiating a biological sample with light.

18. The biological sample analysis system according to claim 1, further comprising:
a sorting unit for sorting target particles from particles in a biological sample on a basis of the light intensity data.

19. A biological sample analysis method comprising:
a detection step of detecting light generated by light irradiation to particles; and
an information processing step of processing light intensity data detected in the detection step,
wherein, in the information processing step, processing of specifying particles having predetermined characteristics from multiple kinds of particles having different characteristics on a basis of the light intensity data generated by light irradiation to a sample containing particle groups including the multiple kinds of particles having different characteristics is executed.

20. A program to execute processing of detecting light generated by light irradiation to particles, processing detected light intensity data, and specifying particles having predetermined characteristics from multiple kinds of particles having different characteristics on a basis of the light intensity data generated by light irradiation to a sample containing particle groups including the multiple kinds of particles having different characteristics.
